(19) United States
(12) Patent Application Publication
(10) Pub. No.: US 2013/0208278 A1
(43) Pub. Date: Aug. 15, 2013

(54) ALIGNMENT APPARATUS AND METHOD

(71) Applicant: Sahag DARDARIAN, Silver Spring, MD (US)

(72) Inventor: Sahag DARDARIAN, Silver Spring, MD (US)

(21) Appl. No.: 13/372,785

(22) Filed: Feb. 14, 2012

(51) Int. Cl. G01B 11/14

(52) U.S. Cl. 356/400

(57) ABSTRACT

An alignment device for conducting single axis alignment of a workpiece is provided. The alignment device has a holder positioned on a worktable. The holder is rotatable about an axis and holds the workpiece. The alignment device also has a light source that emits a beam of light toward the workpiece. Optics positioned at an emitting end of the light source and a slit portion provided between the light source and the optics cooperate to shape the light beam emitted from the light source to be elongated in a direction orthogonal to the worktable. A photodetector is disposed in the vicinity of the light source and in the orthogonal plane with respect to an optical axis of the light source. A circuit portion determines when a workpiece is aligned with the work table based on the photodetector detecting the reflected beam of light and outputs a signal confirming alignment to a user.

### BACKGROUND

1. Field

An alignment device is provided that is configured to align a workpiece or fixture provided on, for example, a milling machine. In particular, a single axis alignment device, or autocollimator, is proposed that is insensitive to translations of the workpiece or fixture, but can detect rotation of the workpiece or fixture about a single axis in an efficient and cost effective manner.

2. Background

A known method for aligning a workpiece to a milling machine having a cutter is to clamp the workpiece to a bed of the milling machine with a vice, dividing head and/or some other fixture. However, if the workpiece is clamped in the vise and a cut is made using the milling machine, there is no guarantee that the cut has any relationship to any datum on the workpiece. According to the known method, the fixture is aligned to the motion of the bed of the milling machine by attaching a dial indicator to the quill and moving the bed either laterally or back and forth until the dial indicator runs true. In the case of a vise, “true” means that the dial indicator senses no displacement as the vise is moved.

The process of getting the vice to run true is to move the bed while adjusting the vice until a required accuracy of, for example, about 0.001 inch of dial indicator excusion per inch of motion is achieved. If the accuracy is off by 0.005 inches, it may, for example, not be possible to just push the vise to offset the error because true rotation of the vice is seldom achieved and, therefore, a slight amount of translation occurs. In such an instance, the dial indicator has to be reset prior to each attempt at finding a desired angular position. The known alignment device and method involves an iterative process that demands both skill and patience. Eliminating the effects of translation on the positioning of the vice makes the process more efficient and less time consuming.

### SUMMARY

In view of the above, it is desirable to provide a low cost alignment device for machinery that is accurate, easy to use.

In view of the above, a solution may be to provide an alignment device for conducting single axis alignment of a reflective flat surface. A holder may be positioned on a worktable, the holder being rotatable about a single axis parallel to the quill axis and being configured to hold a workpiece having a reflective flat surface. The alignment device may have a light source that is configured to emit a beam of light toward a flat mirror attached to the holder. The light source may be a laser. The beam of light may be elongated in cross section and further may be rectangular in cross section. A slit portion may be provided between the light source and optics. A photodetector may be disposed along an elongated axis of the beam of light. The photodetector may be configured to receive a reflected beam of light from the workpiece and to output a first signal. Further, a circuit portion may be provided that is configured to determine when the workpiece is aligned with a worktable based on the first signal output from the photodetector. In addition, a signal output portion may be provided that provides an indication when the workpiece is aligned based on a second signal output from the circuit portion. The combination of the light source, slit portion and optics may produce a beam of light that is emitted toward the workpiece.

According to some embodiments, the photodetector may have a circular shaped active area or a square shaped active area. Further, the photodetector may include two active areas. The photodetector may be positioned above the light source, or may be positioned below the light source.

In some embodiments, the alignment device may be attached to a base that may be attached to a worktable via an adaptor plate. The adaptor plate is configured to permit the alignment device to be easily removed and reinstalled while maintaining its alignment to the table axis. The display portion may be an LED array, and the circuit portion may be configured to receive an output from the photodetector, which may be a photodiode, and activate the LED array to display an alignment state.

According to some embodiments, the alignment device may be provided in a machine tool to align a workpiece,

In some embodiments, a method of aligning a workpiece with an alignment device may be provided. The method may comprise steps of positioning a workpiece having a flat reflective surface in a holder provided on a worktable, the holder being rotatable about a single axis; emitting, with an alignment device having optics, slit portion and a light source, a beam of light toward the workpiece, the beam of light being elongated in cross section; rotating the workpiece provided in the holder about the single axis; receiving a reflection of the beam of light from the workpiece at a photodetector; detecting the reflected beam of light with the photodetector and outputting a signal based on the detection; determining whether the workpiece is aligned with the worktable based on the signal output by the photodetector; and providing an indication to a user that the workpiece is aligned with the worktable through a signal output device.

### BRIEF DESCRIPTION OF THE DRAWINGS

FIG. 1A illustrates a front view of an alignment device according to one embodiment.

FIG. 1B illustrates a cross-sectional view of FIG. 1 taken along lines 1B-1B in FIG. 1A.

FIG. 2 illustrates a simplified block diagram of the alignment device according to one embodiment mounted on a milling machine.

FIG. 3A illustrates the alignment device according to one embodiment when a workpiece is not aligned.

FIG. 3B illustrates how the alignment device is insensitive to translations in the X, Y and Z directions.

FIG. 4A illustrates a beam impinging on a surface of a photodetector according to one embodiment.

FIG. 4B illustrates a graph of the voltage output by the photodetector as a function of displacement.

FIG. 4C illustrates another embodiment of a photodetector surface.

FIG. 5 illustrates how the alignment device can be aligned to a table axis according to one embodiment.

FIG. 6 illustrates method steps associated with aligning a workpiece with the alignment device.

FIG. 7 illustrates a circuit diagram according to one embodiment.

FIG. 8 illustrates a circuit diagram according to another embodiment.

FIG. 9A illustrates an embodiment in which there are two photodetectors.

FIG. 9B illustrates a graph of the voltage output by the photodetectors as a function of displacement for the embodiment illustrated in FIG. 9A.

### DETAILED DESCRIPTION OF EMBODIMENTS

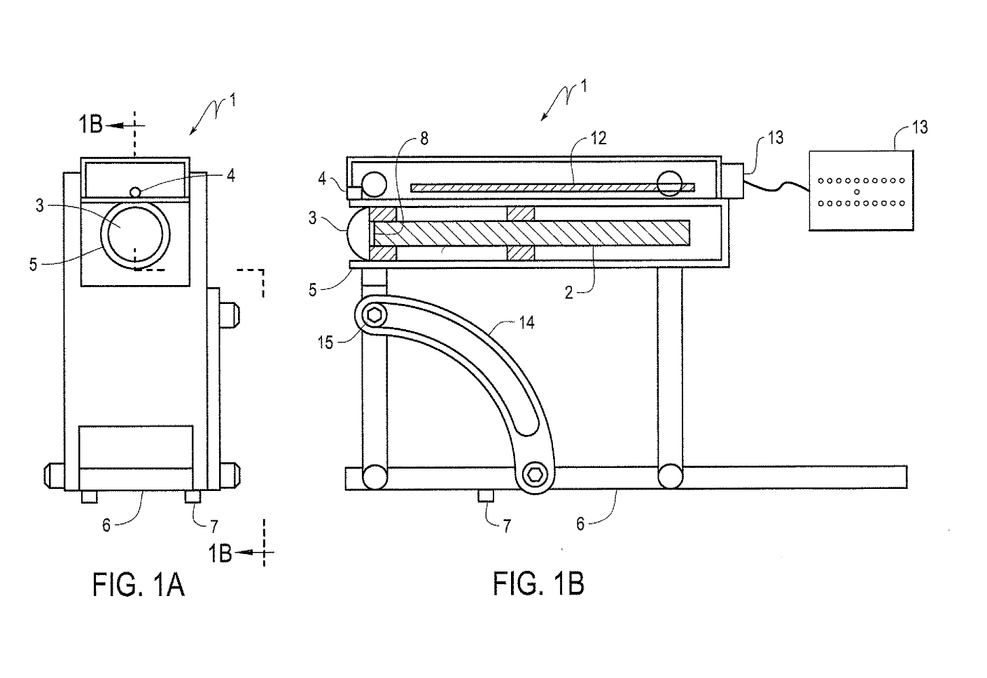

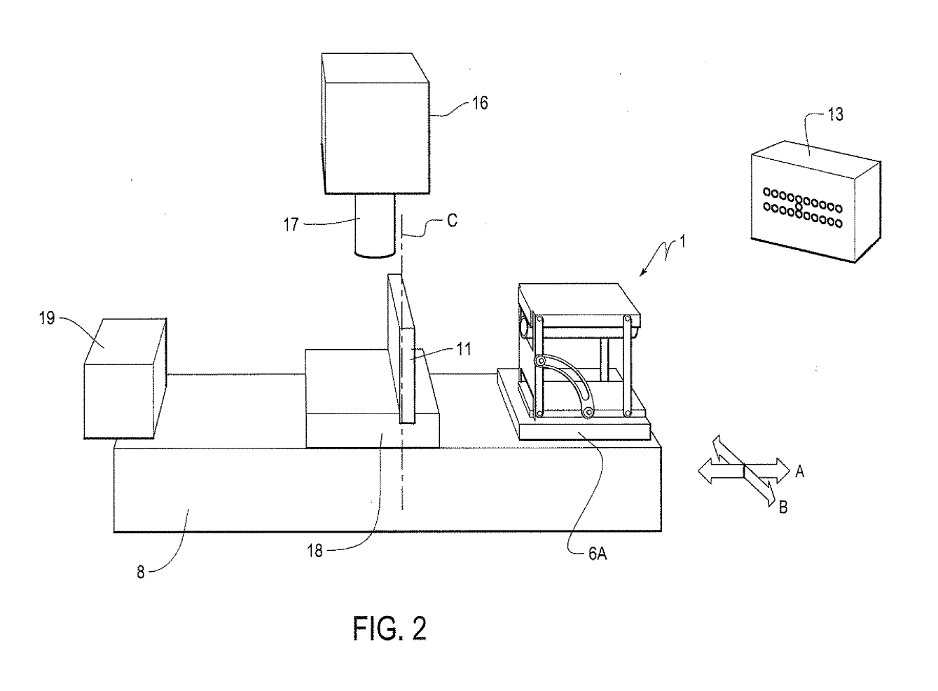

FIG. 1A illustrates a front view of the alignment device I, which includes a light source 2, optics 3, and a photodetector 4. The light source 2 can be a laser or any other suitable light source. As seen in FIG. 1A, the light source 2 is provided in a housing 5 that is attached to a base 6. Locator pins 7 are provided on a bottom side of the base 6 so that the base 6 can be attached to a worktable 8 via an adaptor plate 6A (see FIG. 2). The adaptor plate 6A is configured to remain on the worktable 8 in situations when the alignment device is removed from the worktable 8. The adaptor plate 6A has recesses (not shown) that are configured to receive the locator pins 7 on the base 6. Repeatability of the alignment of the housing 5 to the workpiece is provided by the locator pin 7/recess arrangement.

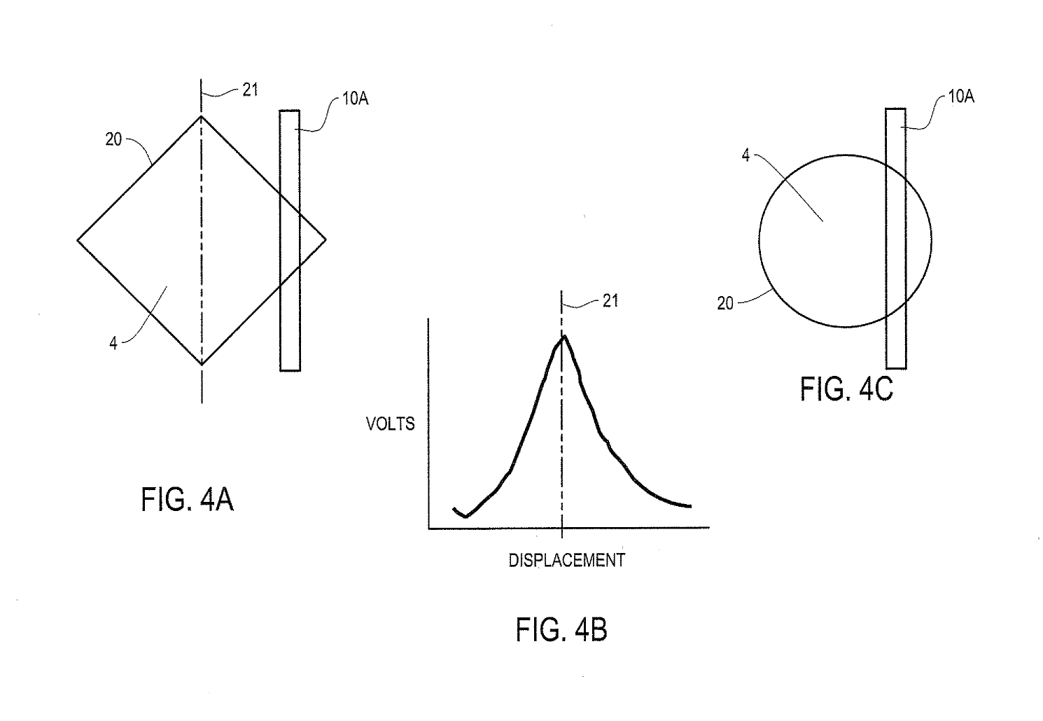

FIG. 1B illustrates a partial cross-sectional view of the alignment device 1 taken along lines 1B-1B in FIG. 1A. As seen in FIG. 1B, a plate 8 having a slit portion is provided between the light source 2 and the optics 3. The optics 3 may comprise one or more lenses one of which may be a cylindrical lens. The combination of the light source 2, the plate 8 and the optics 3 produces a beam of light 10 that can be emitted toward a workpiece 11 (see FIG. 2). The beam of light 10 may be elongated in cross section, and may be rectangular in cross section (see FIG. 4A). The photodetector 4 may be, for example, a photodiode that is configured to detect a reflection of the beam of light 10 from the workpiece 11. The photodetector 4 may be any other type of a detector, and is not limited to a photodiode. For example, the photodetector 4 may be any one of a charge coupled device (CCD), a photomultiplier a channel multiplier or the like. The photodetector 4 outputs a signal to a circuit portion 12, which in turn outputs a signal to a signal output portion 13 that is configured to indicate when the workpiece 11 is aligned. The signal output portion 13 may be any type of device that can indicate to a user that the workpiece 11 is aligned. For example, the signal output portion 13 can provide any one of, or a combination of, a visual, audible or tactile indication of alignment to the user. FIGS. 1A and 1B illustrate the photodetector 4 being positioned above the light source 2. However, the photodetector 4 may also be positioned below the light source 2.

In the embodiment illustrated in FIGS. 1A and 1B, the height of the alignment device 1 can be adjusted, for example, though a quadric link configuration having a height adjustment locking bar 14 that allows the height to be adjusted and then locked into place through a nut 15.

FIG. 2 illustrates an exemplary application of the alignment device 1 when used to align a workpiece 11 on a milling machine 16. The alignment device 1 can be used with any number of different types of machines, and is not limited to use with the milling machine 16. The milling machine 16 has a quill 17, a vise 18 and a worktable 8, which can move in the direction of mows A and B. The workpiece 11 can be secured in a holder that can rotate about a single axis. For the purposes of this disclosure, it is understood that the workpiece 11 has a flat reflective surface for the purpose of aligning the workpiece 11 to the worktable 8. It is also understood that, after alignment is achieved, the workpiece 11 can then removed and an item to be machined, for example, is placed in its stead. As a result of the alignment of the workpiece 11, the item to be machined also is aligned. In the embodiment illustrated in FIG. 2, the workpiece 11 is clamped in the vise 18, which is to be aligned around the table motion. For the purposes of aligning the workpiece 11, the workpiece 11 can be, for example, a flat mirror. The alignment device 1 can be used for single axis alignment of any flat reflective surface, and is not limited to alignment of a flat mirror. After the alignment device 1 has been aligned to the table (described below), the workpiece is rotated about an axis C that is perpendicular to the top surface of the worktable 8 until the signal output portion 13 indicates that the workpiece 11 is aligned. To verify that the alignment device 1 has not shifted, a secondary reference 19 may also be provided on the worktable 8 to provide a way of checking to ensure that the alignment device 1 is still aligned with the axis of the worktable 8.

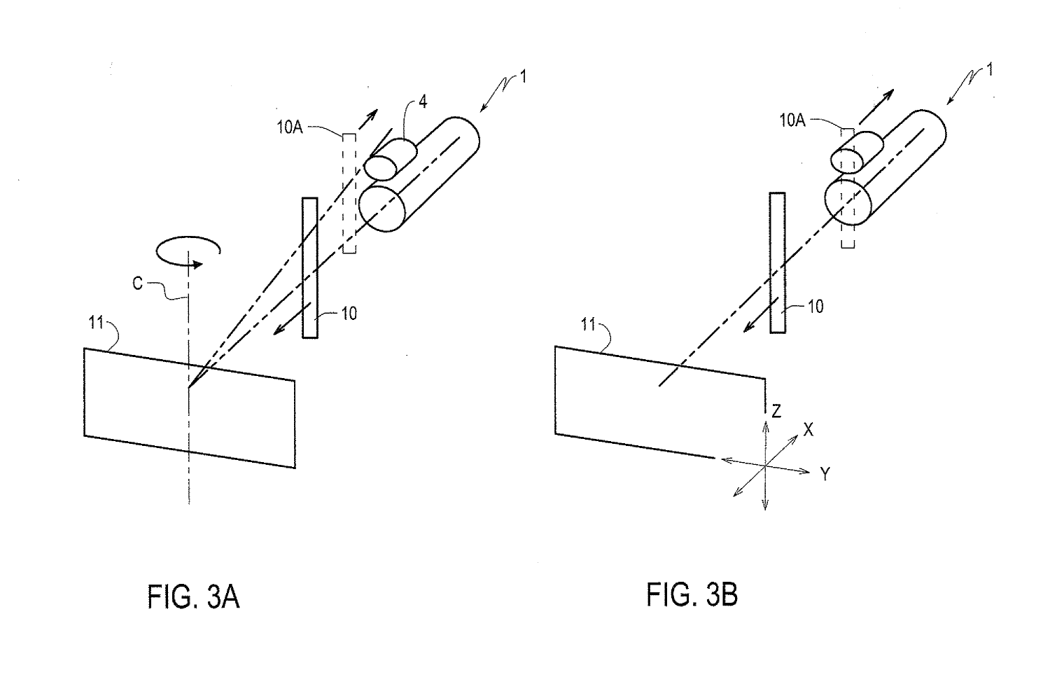

FIGS. 3A and 3B illustrate how the alignment device I detects rotation of the workpiece 11 about the vertical axis C. As seen in FIGS. 3A and 3B, the beam of light 10 is emitted from the alignment device 1 toward the workpiece 11. A return image of the beam of light 10 is reflected back toward the alignment device 1 as a reflected beam of light 10A. Depending on the rotation of the workpiece 11 about the vertical axis C, the photodetector 4 detects whether the workpiece 11 is aligned. In FIG. 3B, the reflected beam of light 10A is reflected directly back toward the alignment device 1 when the workpiece 11 is aligned. Due to this configuration, the alignment device 1 is insensitive to small translations of the workpiece 11 in the X, Y and Z directions and small rotations about the Z axis other than the sensitive axis. That is, the alignment device 1 only detects rotation of the workpiece 11 about the vertical axis C. FIG. 3A, on the other hand, illustrates a situation in which the reflected beam of light 10A is offset with respect to the photodetector 4 due to the rotation of the workpiece 11 about the vertical axis C.

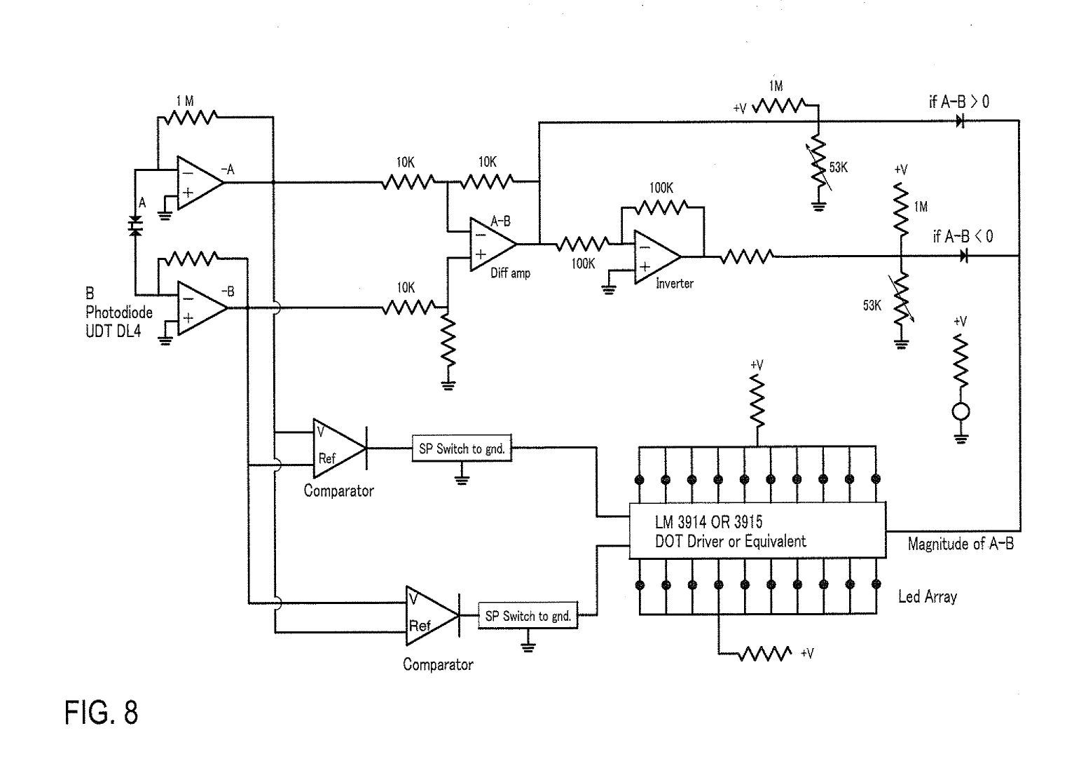

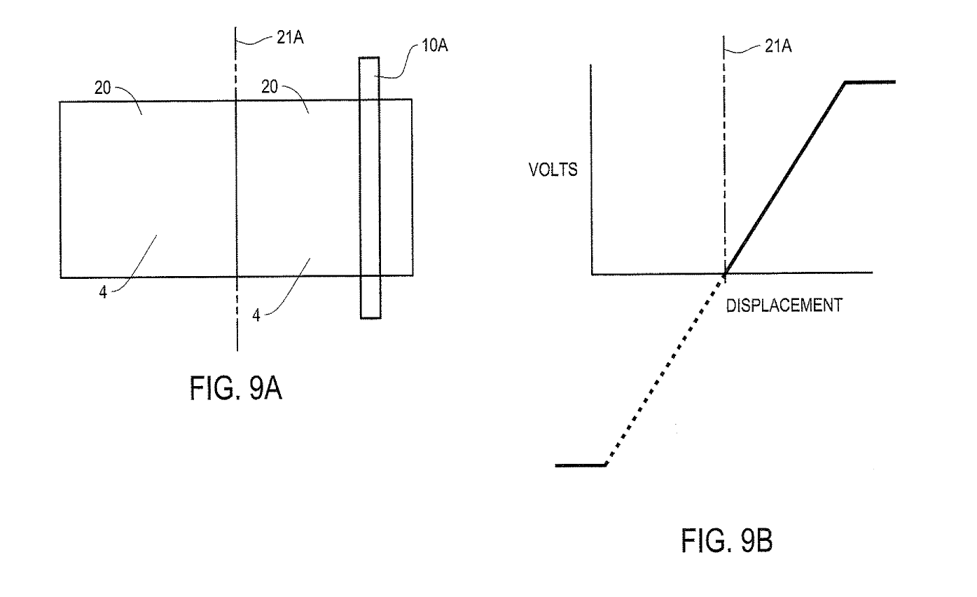

FIG. 4A illustrates how movement of the reflected beam of light 10 across a detecting surface 20 of the photodetector 4 results in a determination that the workpiece 11 is aligned. As the reflected beam of light 10A moves in the direction of the arrow C, more light is detected by the photodetector 4 resulting in a higher voltage output (see FIG. 4B). Once the reflected beam of light 10 reaches the peak position 21, the workpiece 11 is aligned. FIG. 4B illustrates a graph of the voltage as a function of displacement. As can be seen from FIG. 4B, the peak voltage corresponds to the peak position 21. When the reflected beam of light 10A reaches the peak position 21, the circuit portion 12 may cause the signal output portion 13 to indicate that the workpiece 11 is aligned. The photodetector 4 in FIG. 4A is illustrated as having a square shaped active area. However, as illustrated in FIG. 4C, the photodetector 4 can also have a circular active area. The photodetector 4 is not limited to circle and a square shaped active areas, and can be any shape as long as the shape of the active area results in a peak position indicating alignment of the workpiece 11. Further, the photodetector 4 can include more than one active area as illustrated, for example, in FIG. 9A, which illustrates two photodetectors 4. FIG. 9B illustrates a graph of the voltage, as a function of displacement, for the circuit diagram illustrated in FIG. 8. The outputs from each active area are subtracted from each other to generate a null. As can be seen from FIG. 9B, the null voltage corresponds to the null position 21A. When the reflected beam of light 10A reaches the null position 21A, the circuit portion 12 may cause the signal output portion 13 to indicate that the workpiece 11 is aligned. To ensure that the signal from the photodetector 4 is not affected by relative motion of the reflected beam of light 10A along an axis perpendicular to the worktable 8, the slit portion can be rotated to minimize the change in the signal when the reflected beam of light 10A is displaced along the axis perpendicular to the worktable 8. This can be accomplished by optically moving the reflected beam of light 10A along the axis and adjusting the rotational orientation of the slit portion to minimize the signal error from the photodetector 4.

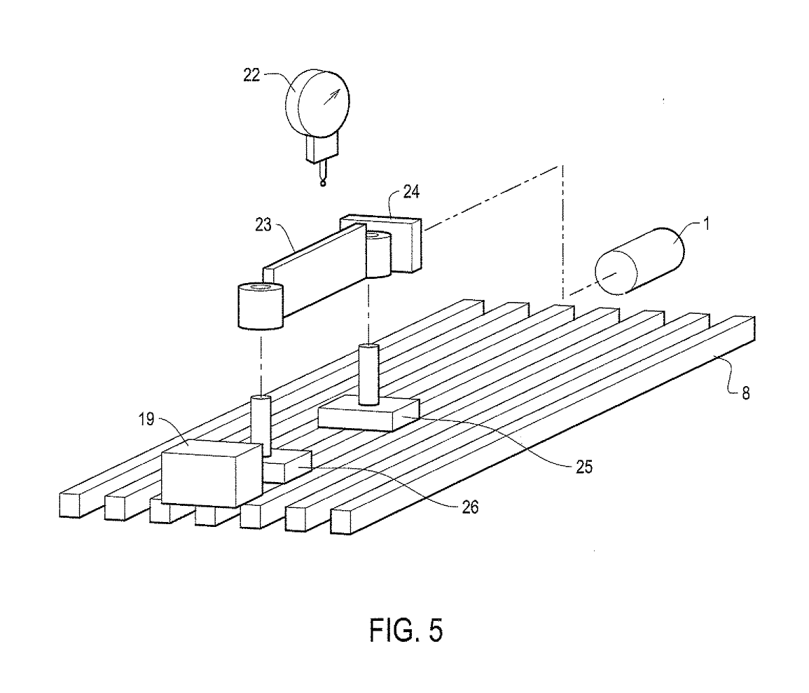

Referring to FIG. 5, it will now be described how the alignment device 1 is initially aligned with the movement axis of the worktable 8. To align the alignment device 1 to the movement axis of the worktable 8, a dial indicator 22 is used to align a bar 23 to an axis of the worktable 8. A mirror 24, whose surface normal is aligned to the long axis of the bar 23, is provided on an end of the bar 23 that faces the alignment device 1. The dial indicator 22 is used to align the bar 23 along the axis of the worktable 8 by pivoting the bar 23 about a fixed post 25. An adjustable post 26 is provided on an end of the bar that is opposite to the end having the fixed post 25. The adjustable post 26 and the fixed post 25 are provided to align the bar 23 with the axis of the worktable 8. Once the bar 23 is aligned with the axis of the worktable 8, the adjustable post 26 is fixed to the worktable 8 by means of, for example, a magnetic chuck. Once the bar 23 is aligned, the alignment device 1 is rotated to indicate that alignment has been achieved. After the alignment device 1 is aligned, the bar 23 is removed and the secondary reference 19 is provided to ensure that no changes have occurred since the initial alignment of the alignment device 1. The alignment of the alignment device 1 with the movement axis of the worktable 8 need only be performed infrequently. Thus, these steps do not affect the efficiency or ease of use of the alignment device 1.

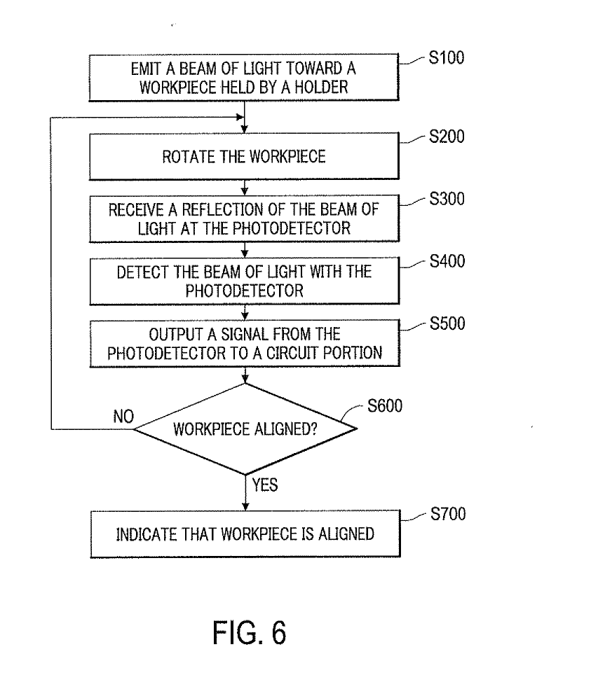

FIG. 6 is a block diagram illustrating method steps that may be used in aligning the workpiece 11 with the alignment device 1. In step S100, a beam of light 10 is emitted from the alignment device 1. In step S200, the workpiece 11 is rotated about a single axis. In step S300, a reflection of the beam of light from the workpiece 11 is received at a photodetector 4. In step S400, the photodetector 4 detects the reflected beam of light 10. In step S500, the photodetector 4 outputs a signal based on the amount of the beam of light 10 detected by the photodetector 4 to a circuit portion 12. In step S500, it is determined, via the circuit portion 12, whether the workpiece 11 is aligned based on an output from the photodetector 4. If the answer in S600 is yes, then the signal output portion 13 is activated in step S700 indicating alignment. In the answer in step S600 is no, then the process returns to step S200 and the workpiece 11 is rotated again.

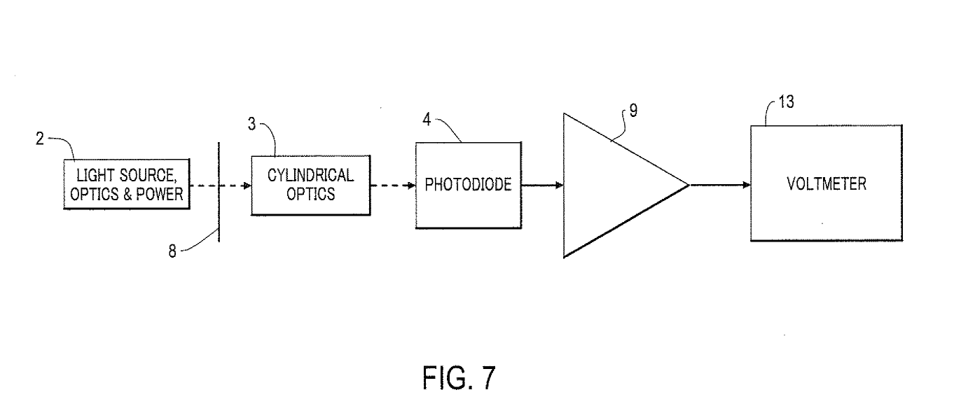

FIG. 7 illustrates the circuit portion 12 according to one embodiment. As illustrated in FIG. 7, the output of the photodetector 4 passes through a low drift amplifier 9, which in turn outputs a signal to the signal output portion 13, which is illustrated in FIG. 7 as a voltmeter.

FIG. 8 illustrates the circuit portion 12 according to another embodiment in which the photodetector 4 has two active areas (see FIG. 9A), the outputs of which are used to activate an LED array that indicates alignment of the workpiece 11. Frequency compensation of the amplifiers and signal shaping elements are not shown in FIG. 8.

What has been described and illustrated herein are preferred embodiments of the invention along with some variations. The terms, descriptions and figures used herein are set forth by way of illustration only and are not meant as limitations. Those skilled in the art will recognize that many variations are possible within the spirit and scope of the disclosure.

What is claimed is:

1. An alignment device for conducting single axis alignment of a reflective flat surface, the alignment device comprising:
a holder that is positioned on a worktable, the holder being rotatable about the single axis and being configured to hold a workpiece that has at least one reflective flat surface;
a light source that is mounted to the worktable and that s configured to emit a beam of light toward the workpiece when positioned in the holder;
optics positioned at an emitting end of the light source, and a slit portion provided between the light source and the optics, the optics and the slit portion cooperating to shape a light beam emitted from the light source to have an elongated axis that is orthogonal to the worktable;
a photodetector disposed in the vicinity of the light source, the photodetector being positioned in a plane orthogonal to the worktable and configured to receive a reflected beam of light from the workpiece and to output a first signal, the first signal being an indicator of an amount of the received reflected beam of light;
a circuit portion that is configured to determine when the workpiece is aligned with a worktable based on the first signal output by the photodetector; and
a signal output portion that indicates when the workpiece is aligned based on a second signal output from the circuit portion.

2. The alignment device according to claim 1, wherein the photodetector has a circular shaped active area.

3. The alignment device according to claim 1, wherein the photodetector has a square shaped active area.

4. The alignment device according to claim 1, wherein the photodetector includes more than one active area.

5. The alignment device according to claim 1, wherein the light source is mounted to the worktable via an adaptor plate.

6. The alignment device according to claim 1, wherein the photodetector is positioned above the light source in the orthogonal plane.

7. The alignment device according to claim 1, wherein the photodetector is positioned below the light source in the orthogonal plane.

8. The alignment device according to claim 4, wherein the signal output portion is a display portion with an LED array, and
the circuit portion is configured to receive the signal output from the photodetector and to activate the LED array of the display portion to display an alignment status.

9. The alignment device according to claim 1, wherein
the beam of light is rectangular in cross section.

10. A machine tool comprising the alignment device according to claim 1.

11. A method of aligning a workpiece with an alignment device having a light source that is configured to emit a beam of light toward a workpiece, optics positioned at an emitting end of the light source; a slit portion provided between the light source and the optics; and a photodetector disposed in the vicinity of the light source, the method comprising;
positioning a workpiece in a holder provided on a worktable, the holder being rotatable about a single axis;
emitting, via the optics, slit portion and light source, a beam of light toward the workpiece, the optics and the slit portion cooperating to shape the beam of light to have an elongated axis that lies in a plane passing through an optical axis of the light source, the plane being orthogonal to the worktable;
rotating the workpiece provided within the holder about the single axis;
receiving a reflection of the beam of light from the workpiece by the photodetector, the photodetector being positioned in the plane orthogonal to the worktable;
detecting an intensity of the reflected beam of light with the photodetector;
outputting a signal from the photodetector based on the detected intensity;
determining that the workpiece is aligned with the worktable based on the signal output by the photodetector; and
providing an indication to a user that the workpiece is aligned with the worktable through a signal output device.

12. The method according to claim 11, further comprising:
verifying that the alignment device is aligned to the worktable by emitting the beam of light toward a secondary reference positioned on an opposite end of the worktable to ensure alignment if the alignment device is removed.

13. The method according to claim 11, wherein
the beam of light is rectangular in cross section.

14. The alignment device according to claim 1, wherein the light source is a laser.

15. The method according to claim 11, wherein the light source is a laser.

16. The alignment device according to claim 1, wherein
the photodetector includes a single active area,
the signal output portion is a voltmeter, and
the circuit portion is configured to receive the signal output from the photodetector and to activate the voltmeter of the display portion to display an alignment status.
